(19) United States
(12) Patent Application Publication
(10) Pub. No.: US 2026/0177171 A1
(43) Pub. Date: Jun. 25, 2026

(54) METHOD OF JOINING CLADDED PIPE

(71) Applicant: Paul Po CHENG, London (CA)

(72) Inventor: Paul Po CHENG, London (CA)

(21) Appl. No.: 19/421,017

(22) Filed: Dec. 16, 2025

Related U.S. Application Data
(60) Provisional application No. 63/736,238, filed on Dec. 19, 2024.

(51) Int. Cl. F16L 13/02

(52) U.S. Cl. CPC F16L 13/0263

(57) ABSTRACT

The disclosure provides a system and method of joining cladded pipe including providing first and second cladded pipes having respective first and second base elements and first and second cladding elements secured to the base elements. The first and second base elements include respective first and second pockets at respective first and second ends of the first and second cladded pipes. The cladded pipes are positioned to locate the first and second ends opposite to each other, to define a gap therebetween. The first and second ends are then heated to a hot working temperature and the cladded pipes are subjected to a translocation and engagement motion to secure the first and second ends together.

### CROSS-REFERENCE TO OTHER APPLICATIONS

The disclosure claims priority from U.S. Provisional Application No. 63/736,238 filed Dec. 19, 2024 which is hereby incorporated by reference.

### FIELD OF THE DISCLOSURE

The disclosure is generally directed at joining structural elements, and more specifically, at a method of joining cladded pipe.

### BACKGROUND OF THE DISCLOSURE

Conventional cladded pipe includes a base element (e.g., steel) that is protected by a cladding element secured to the base element. Typically, the cladding element is highly resistant to liquids or other substances that are to be carried in the cladded pipe. In most cases, the base element is made of a relatively less expensive material and the cladding element is a made of a relatively more expensive material.

In most cases, the base element forms by far the larger portion of the cladded pipe while cladding element is usually a relatively thin layer.

However, because cladded pipe includes two or more materials, joining cladded pipes end-to-end is often difficult. Conventional welding methods are not well-suited for joining cladded pipes together because the cladding material is inside the pipe, defining an inner diameter. Also, where the joined pipes are intended to allow fluid flow therethrough, it is usually necessary that the joined pipes permit a generally smooth (non-turbulent, or laminar) flow therethrough. This typically requires that the inner diameter be consistent throughout. In the prior art, however, some of the cladding material may be extruded inwardly (i.e., to decrease the inner diameter at the connection), when two cladded pipes are joined.

Therefore, there is provided a novel method and system for joining cladded pipe.

### SUMMARY OF THE DISCLOSURE

For the foregoing reasons, there is a need for a method of joining a cladding material to a base element that overcomes or mitigates the defect or deficiencies of the prior art.

In its broad aspect, the disclosure provides a method of joining cladded pipe including providing first and second cladded pipes having respective first and second base elements and first and second cladding elements secured to the base elements. The first and second base elements include respective first and second pockets at respective first and second ends of the first and second cladded pipes. The cladded pipes are positioned to locate the first and second ends opposite to each other, to define a gap therebetween.

One or more heating elements are positioned in the gap, for heating heated parts of the first and second cladded pipes to a hot working temperature, at which the heated parts are plastically deformable. The heated parts are covered by an inert atmosphere.

The heating elements are energized, to heat the heated parts to the hot working temperature. Once the heated parts are at the hot working temperature, the first and second ends are engaged with each other. While the heated parts are at the hot working temperature and engaged with each other, one or both of the cladded pipes are moved relative to the other, for shearing the plastically deformable material in the heated parts.

### BRIEF DESCRIPTION OF THE DRAWINGS

The disclosure will be better understood with reference to the attached drawings, in which:

FIG. 1A is a cross-section of parts of first and second cladded pipes positioned with ends facing each other, with a heating element positioned between the ends;

FIG. 1B is a cross-section of an alternative embodiment of the first and second cladded pipes in which extension portions of the cladding elements thereof include bent segments that are formed for engagement, when the first and second cladded pipes are engaged end-to-end;

FIG. 2 is a cross-section of the parts of the first and second cladded pipes of FIG. 1A or 1B showing extension portions of first and second cladding elements that are folded into respective pockets in the base element of the cladding pipes;

FIG. 3 is a partial cross-section of the cladded pipes of FIGS. 1A, 1B and 2, in which the cladded pipes are joined together;

FIG. 4 is a partial cross-section of a product formed when the cladded pipes are joined together;

FIG. 5 is a cross-section of parts of first and second cladded pipes positioned with ends facing each other, with a heating element positioned between the ends, the first and second cladded pipes including base elements with internal wall surfaces thereon proximal to the cladding element;

FIG. 6 is a cross-section of the parts of the first and second cladded pipes of FIG. 5 in which extension portions of the cladding elements are folded onto the internal wall surfaces;

FIG. 7 is a partial cross-section of a product formed when the cladded pipes are joined together;

FIG. 8 is a cross-section of parts of first and second cladded pipes positioned with ends facing each other, with a heating element positioned between the ends, the first and second cladded pipes including base elements with internal wall surfaces thereon proximal to the cladding element and external wall surfaces proximal to outer surfaces of the cladded pipes;

FIG. 9 is a cross-section of the parts of the first and second cladded pipes of FIG. 8 in which extension portions of the cladding elements are folded onto the internal wall surfaces; and

FIG. 10 is a partial cross-section of a product formed when the cladded pipes are joined together;

### DETAILED DESCRIPTION OF THE EMBODIMENTS

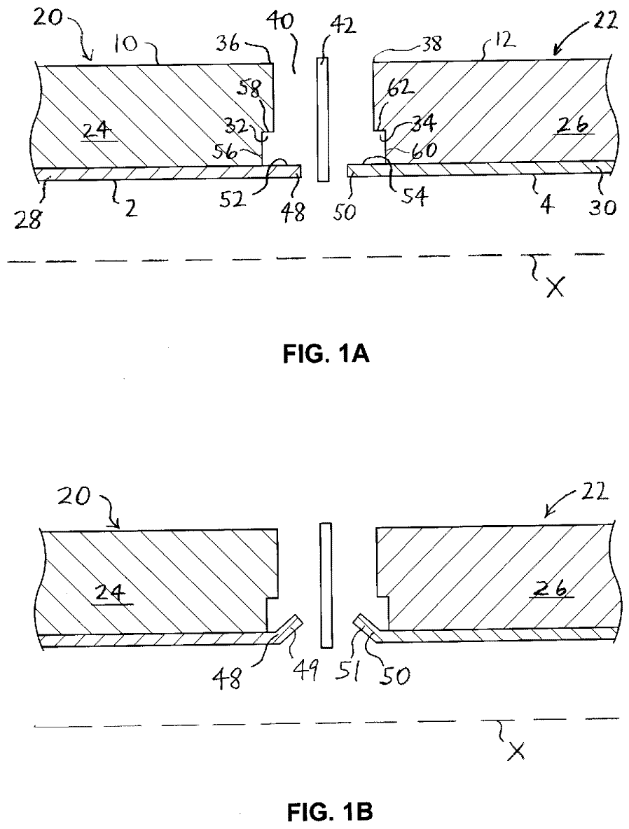

In the attached drawings, like reference numerals designate corresponding elements throughout. Reference is first made to FIGS. 1 to 4 to describe an embodiment of a method in accordance with the invention.

As can be seen in FIG. 1A, in one embodiment, first and second cladded pipes 20, 22 having respective first and second base elements 24, 26 and respective first and second cladding elements 28, 30 are provided. The base element 24 may be referred to as a first cladded pipe base element and the base element 26 may be referred to as a second cladded pipe base element. The cladding element 28 may be referred to as a first cladded pipe cladding element and the cladding element 30 may be referred to as a second cladded pipe cladding element. In the current embodiment, the first and second cladding elements 28, 30 are secured to their respective first and second base elements 24, 26. It will be understood that only one side of each of the cladded pipes 20, 22 is illustrated in FIG. 1A.

The cladded pipes 20, 22 are aligned so that they have a common axis “X”. Those skilled in the art would appreciate that interior surfaces 2, 4 of the first cladded pipe and second cladded pipe cladding elements 28, 30 are intended to define a single, uniform interior pipe surface 6 (FIGS. 3 and 4) after the pipes 20, 22 are joined together to form a unitary product 8 (FIG. 4). Also, the exterior surfaces 10, 12 of the first cladded pipe and second cladded pipe base elements 24, 26 are intended to define a single, uniform exterior pipe surface 14 after the pipes 20, 22 are joined together to form the product 8 (FIG. 4).

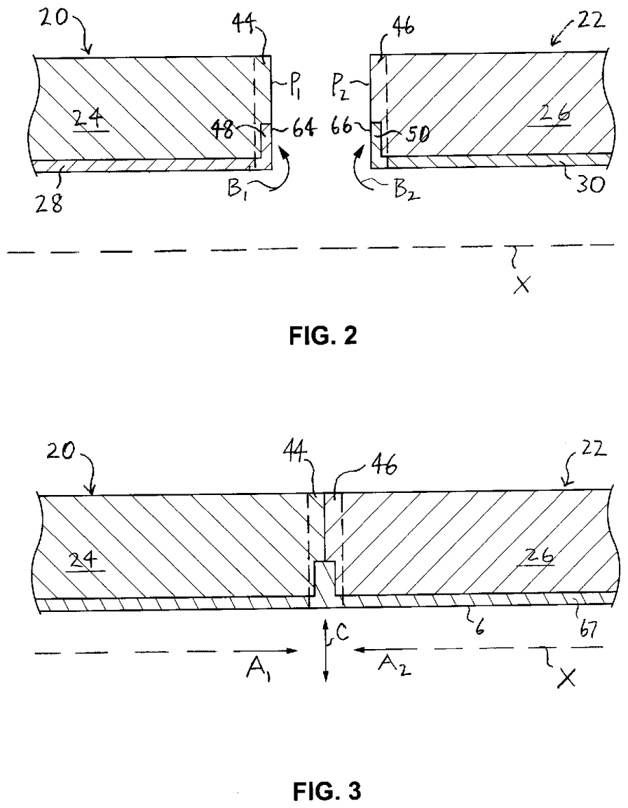

The first and second base elements 24, 26 include respective first cladded pipe and second cladded pipe pockets 32, 34 at respective ends 36, 38 of the first and second cladded pipes 20, 22. As can be seen in FIG. 2, in one embodiment, the cladding elements 28, 30 are partially defined by planar surfaces “P₁”, “P₂” that are parallel, or substantially parallel, to each other when the ends 36, 38 are positioned opposed to each other. In one embodiment, the planar surfaces “P₁”, “P₂” are orthogonal to the common axis “X”.

The first and second cladded pipes 20, 22 are initially positioned to locate the first end 36 opposite to the second end 38 to define a gap 40 therebetween. One or more heating elements 42 are positioned in the gap 40 to heat sections or areas of the cladded pipes 20, 22. The heated sections may be seen as heated part 44 of the first cladded pipe and heated part 46 of the second cladded pipe. As will be described, the heating element 42 is for heating the first and second heated parts 44, 46 (FIG. 2) of the first and second cladded pipes to a hot working temperature, at which the heated parts 44, 46 are plastically deformable. It will be understood that the extent or size of each of the heated parts 44, 46 as illustrated in FIGS. 2 and 3 is exaggerated, for clarity of illustration. Also, the heated parts 44, 46 are omitted from FIG. 1A to simplify the illustration.

While only one heating element 42 is shown in FIG. 1A, for clarity of illustration, those skilled in the art would appreciate that the configuration and positioning of the at least one heating element(s) 42 may be determined by practical considerations, e.g., any difficulties encountered in positioning the heating element(s) relative to the base and the cladding elements, and/or also any difficulties encountered in removing the heating element(s) from their respective positions once the first and second heated parts 44, 46 are at their hot working temperature.

As can be seen in FIG. 1A, in one embodiment, respective first and second, or first cladded pipe and second cladded pipe, extension portions 48, 50 of the cladding elements 28, 30 extend toward each other and partially define the pockets 32, 34 to which the extension portions 48, 50 are adjacent. It will be understood that, for clarity of illustration, the extent to which the extension portions 48, 50 extend beyond the planar surfaces “P₁”, “P₂” is exaggerated in FIG. 1A.

As can be seen in FIG. 1A, in one embodiment, the extension portion 48 is partially defined by an inner surface 52 and the opposed interior surface 2. The extension portion 50 is also partially defined by an inner surface 54 and the opposed interior surface 4.

The first pocket 32 is defined by the inner surface 52, a long wall surface 56, and a short wall surface 58. Similarly, the second pocket 34 is defined by the inner surface 54, a long wall surface 60, and a short wall surface 62.

Once the at least one heating element 42 is in position, the sections of the cladded pipes to be heated (such as heated parts 44, 46) are covered with an inert (non-oxidizing) atmosphere. Those skilled in the art would be aware of a suitable inert atmosphere. In some embodiments, the inert atmosphere may be held in place by a suitable container. It will be understood that the container and the inert atmosphere are omitted from the drawings for clarity of illustration.

Next, the at least one heating element 42 is energized, to heat the heated parts 44, 46, such as, but not limited to, by induction. Once the heated parts 44, 46 are at their hot working temperature, the heating element 42 is removed from the gap 40. While the heated parts 44, 46 are at their hot working temperature, the first and second ends 36, 38 are engaged such as schematically shown in FIG. 3.

It will be understood that, when the heated parts 44, 46 are at their hot working temperature, they are subject to plastic deformation where the hot working temperature is less than the melting temperature of the base elements 24, 26 and the cladding elements 28, 30. This means that, in contrast to conventional welding methods, the method of the disclosure does not involve first melting metal, and then allowing the metal to solidify.

As can be seen in FIG. 3, while the heated parts 44, 46 are at their hot working temperature, the first and second ends 36, 38 of the cladded pipes 20, 22 are engaged. In order to achieve this, in one embodiment, one or both of the cladded pipes 20, 22 are subjected to a translocation motion, i.e., one or both may be moved in the directions indicated in FIG. 3 by arrows “A₁”, “A₂”.

Once the first and second ends 34, 36 of the first and second cladded pipes 20, 22 are engaged, one or both of the pipes 20, 22 are subjected to an engagement motion, in which one or both of the pipes 20, 22 moves relative to the other. In one embodiment, arrow “C” in FIG. 3 generally indicates directions of such a relative motion. In other embodiments, the engagement motion may commence before the engagement between the first and second ends 34, 36.

From the foregoing, it can be seen that, when the first and second ends 36, 38 are engaged, the first portions thereof to engage are the first and second extension portions 48, 50. It will be understood that the extension portions 48, 50 are at least partially included in the heated parts 44, 46. The manner in which the extension portions 48, 50 are deformed when the extension portions 48, 50 are urged against each other, due to the translocation motion, is shown in FIG. 2.

It will be understood that, in FIG. 2, the ends 36, 38 of the cladded pipes 20, 22 are shown spaced apart from each other for clarity of illustration, although the deformation illustrated in FIG. 2 occurs when the extension portions 48, 50 are engaged. Such deformation takes place shortly before the surfaces “P₁”, “P₂” are engaged.

As can be seen in FIG. 2, when the extension portions 48, 50 are at their hot working temperature and engage each other, the extension portions 48, 50 are urged into the pockets 32, 34, respectively, as indicated by arrows “B₁”, “B₂”. In the current embodiment, the extension portions 48, 50 are deformed so that the inner surfaces 52, 54 are engaged with the long wall surfaces 56, 60 respectively (FIG. 2). For clarity of illustration, exposed parts of the interior surfaces 2, 4, are identified in FIG. 2 by reference characters 64, 66 respectively.

In an alternative embodiment, illustrated in FIG. 1B, the extension portions 48, 50 are bent segments 49, 51. As can be seen in FIG. 1B, when the first and second pipes 20, 22 are initially engaged end-to-end, the bent segments 49, 51 are positioned so that they will engage each other, and push each other into their respective pockets 32, 34 which are formed to at least partially receive the extension portions 48, 50.

Shortly after the extension portions 48, 50 are deformed and urged into the pockets 32, 34, the planar surfaces “P₁”, “P₂” are urged against each other, such as via the translocation motion, and also the exposed parts 64, 66 are urged against each other.

As the heated parts are at their hot working temperature when the planar surfaces “P₁”, “P₂” and the exposed parts 64, 66 are engaged, then due to the engagement motion, the heated parts 44, 46 are at least partially subjected to shear, to form a zone of recrystallized material with a relatively uniformly fine-grained microstructure that includes at least portions of the heated parts. For convenience, the zone of recrystallized material is identified in FIG. 4 by reference character “Z”. It will be understood that, as illustrated in FIG. 4, the extent of the zone “Z” has been exaggerated, for clarity of illustration. It will be understood that the zone “Z” includes a portion “Q” of a unitary cladding element 67 (FIG. 3) that is joined with the base elements (FIG. 4).

The surfaces that are engaged are also at least partially subsumed in the zone “Z” of recrystallized material (FIG. 4). Such surfaces include the planar surfaces “P₁”, “P₂”, the exposed parts 64, 66 of the interior surfaces 2, 4, and the long wall surfaces 56, 60, and the short wall surfaces 58, 62 of the pockets 32, 34. It is believed that the relatively fine-grained microstructure results from such shearing, while the heated parts are at their hot working temperature.

As can be seen in FIG. 1A, when the ends 36, 38 of the pipes 20, 22 are positioned opposite each other for heating, the extension portions 48, 50 extend toward each other, and also toward the heating element(s) 42, beyond the base elements 24, 26. Those skilled in the art would be aware that the cladding elements 28, 30 may have a higher hot working temperature than the base elements 24, 26. It is believed that, due to the exposed positions of the extension portions 48, 50 and their proximity to the heating element(s) 42, sections or the heated parts of the extension portions 48, 50 are plastically deformable approximately when the heated parts of the base elements 24, 26 are plastically deformable.

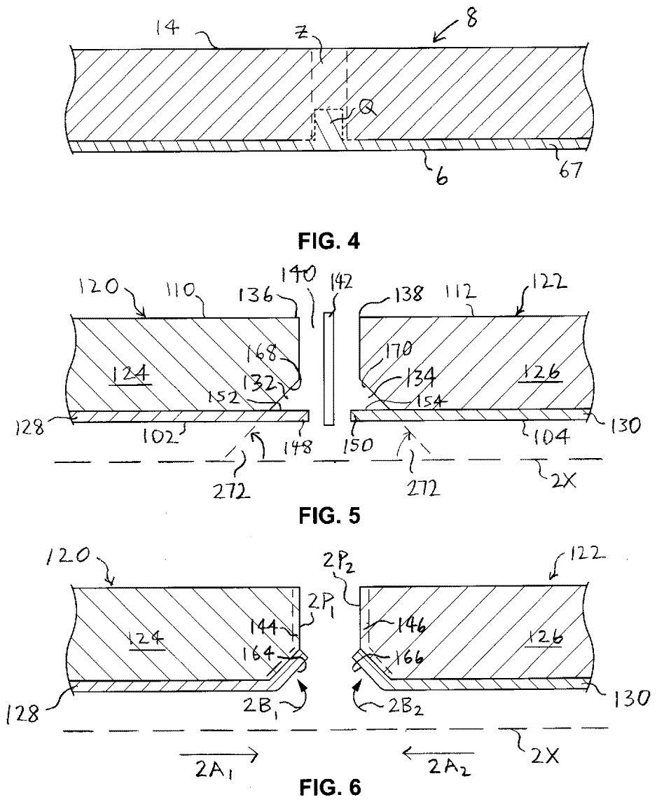

In another embodiment, illustrated in FIGS. 5-7, first and second cladded pipes 120, 122 include respective first cladded pipe base element 124 and second cladded pipe base element 126 and first cladded pipe cladding elements 128 and second cladded pipe cladding elements 130. At respective ends 136, 138 of the first and second cladded pipes 120, 122, the base elements 124, 126 have respective planar surfaces “2P₁”, “2P₂” that are orthogonal to an axis “2X” of the pipes 120, 122 (FIG. 6).

As can be seen in FIG. 5, first and second pockets 132, 134 are formed in the base elements 124, 126 for at least partially receiving extension portions 148, 150 after they have been heated to their hot working temperature. The pockets 132,134 are partially defined by angled internal wall surfaces 168, 170. In one embodiment, the angled internal wall surfaces 168, 170 are positioned to define an acute angle 272 relative to the axis “2X”.

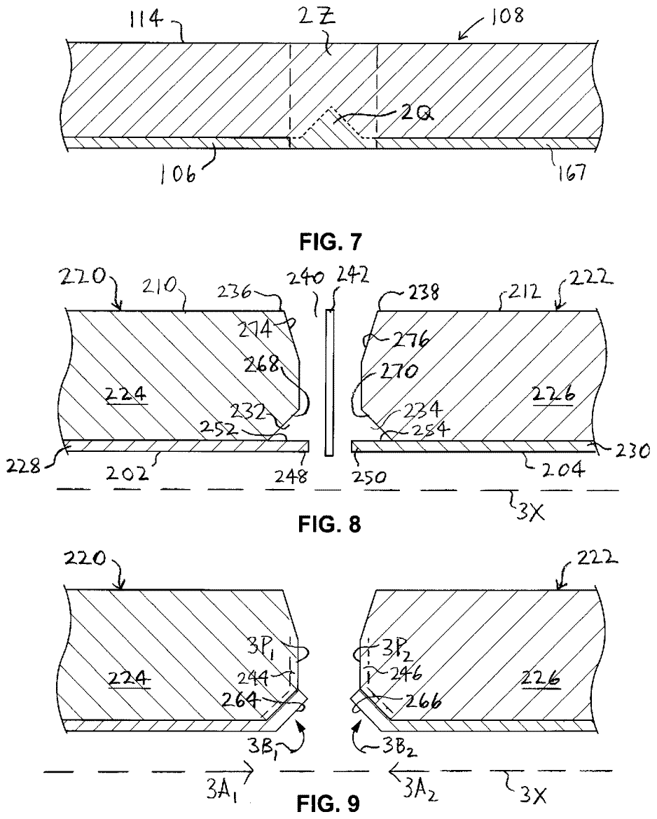

The cladded pipes 120, 122 have respective interior surfaces 102, 104, and respective exterior surfaces 110, 112 (FIG. 5). As will be described, once the cladded pipes 120, 122 are joined together to form a unitary product 108, the interior surfaces 102, 104 preferably form a single, uniform interior pipe surface 106, and the exterior surfaces 110, 112 preferably form a single, uniform exterior pipe surface 114 (FIG. 7).

The first and second cladded pipes 120, 122 are initially positioned to locate the first end 136 opposite to the second end 138 to define a gap 140 therebetween. The cladded pipes 120, 122 are axially aligned, along axis “2X”. One or more heating elements 142 may be positioned in the gap 140. As will be described, the heating element 142 is for heating sections, seen as first and second heated parts 144, 146, of the first and second cladded pipes 120, 122 to a hot working temperature, at which the heated parts 144, 146 are plastically deformable. It will be understood that the extent of the heated parts 144, 146 as illustrated in FIG. 6 is exaggerated, for clarity of illustration. Also, the heated parts 144, 146 are omitted from FIG. 5 to simplify the illustration.

In one embodiment, respective first and second extension portions 148, 150 of the cladding elements 128, 130 extend toward each other and partially define the pockets 132, 134 to which the extension portions 148, 150 are adjacent (FIG. 5). It will be understood that, for clarity of illustration, the extent to which the extension portions 148, 150 extend beyond the planar surfaces “2P₁”, “2P₂” is exaggerated in FIG. 5.

As can be seen in FIG. 5, in one embodiment, the extension portion 148 is partially defined by an inner surface 152 and the opposed interior surface 102. The extension portion 150 is also partially defined by an inner surface 154 and the opposed interior surface 104.

The first pocket 132 is defined by the inner surface 152 and the internal wall 168. Similarly, the second pocket 134 is defined by the inner surface 154 and the internal wall 170.

Once the at least one heating element 142 is in position, sections of the ends of the first and second cladded pipes 120, 122 (which may be seen as heated parts 144, 146) are covered with an inert (non-oxidizing) atmosphere. Those skilled in the art would be aware of a suitable inert atmosphere. Also, those skilled in the art would be aware that the inert atmosphere may be held in place by a suitable container. It will be understood that the container and the inert atmosphere are omitted from the drawings for clarity of illustration.

Next, the at least one heating element 142 is energized, to heat the heated parts 144, 146. Once the heated parts 144, 146 are at their hot working temperature, the heating element 142 is removed from the gap 140. While the heated parts 144, 146 are at their hot working temperature, the first and second ends 136, 138 are engaged.

Only one heating element 142 is shown in FIG. 5, for clarity of illustration. Those skilled in the art would appreciate that the configuration and positioning of the heating element(s) 142 may be determined by practical considerations, e.g., any difficulties encountered in positioning the heating element(s) relative to the base elements and the cladding elements, and also any difficulties encountered in removing the heating element(s) from their respective positions once the first and second heated parts 144, 146 are at their hot working temperature.

When the heated parts 144, 146 are at their hot working temperature, they are subject to plastic deformation where the hot working temperature is less than the melting temperature of the base elements 124, 126 and the cladding elements 128, 130. This means that, in contrast to conventional welding methods, the method of the disclosure does not involve first melting metal, and then allowing the metal to solidify.

As can be seen in FIGS. 6 and 7, while the heated parts 144, 146 are at their hot working temperature, the first and second ends 136, 138 of the cladded pipes 120, 122 are preferably engaged. In order to achieve this, one or both of the cladded pipes 120, 122 may be subjected to a translocation motion, i.e., one or both cladded pipes 120, 122 may be moved in the directions indicated in FIG. 6 by arrows “2A₁”, “2A₂”.

Once the first and second ends 134, 136 of the first and second cladded pipes 120, 122 are engaged, one or both of the pipes 120, 122 may be subjected to an engagement motion, in which one or both of the pipes 120, 122 moves relative to the other.

From the foregoing, it can be seen that, when the first and second ends 136, 138 are engaged, the first portions thereof to engage are the first and second extension portions 148, 150. It will be understood that the extension portions 148, 150 are at least partially included in the heated parts 144, 146. The manner in which the extension portions 148, 150 are deformed when the extension portions 148, 150 are urged against each other, due to the translocation motion, is shown in FIG. 6. Such deformation takes place shortly before the planar surfaces “2P₁”, “2P₂” are engaged.

In an alternative embodiment, the extension portions 148, 150 may include respective bent segments thereof (such as schematically shown in FIG. 1B), formed for engagement with each other when the cladded pipes 120, 122 are engaged with each other end-To-end.

It will be understood that, in FIG. 6, the ends 136, 138 of the cladded pipes 120, 122 are shown spaced apart from each other for clarity of illustration, although the deformation illustrated in FIG. 6 occurs when the extension portions 148, 150 are engaged.

As can be seen in FIG. 6, when the extension portions 148, 150 engage each other, the extension portions 148, 150 are urged into their respective pockets 132, 134, as indicated by arrows “2B₁”, “2B₂”. As the extension portions 148, 150 are at their hot working temperature, the extension portions 148, 150 are deformed so that the inner surfaces 152, 154 are engaged with the internal walls 168, 170 respectively. For clarity of illustration, exposed parts of the interior surfaces 102, 104, are identified in FIG. 6 by reference characters 164, 166 respectively.

Shortly after the extension portions 148, 150 are deformed and urged into the pockets 132, 134, the planar surfaces “2P₁”, “2P₂” are urged against each other, and also the exposed parts 164, 166 are urged against each other.

When the heated parts are at their hot working temperature, the planar surfaces “2P₁”, “2P₂” are engaged, and the exposed parts 164, 166 are engaged, then due to the engagement motion, the heated parts 144, 146 are at least partially subjected to shear, to form a zone of recrystallized material with a relatively uniformly fine-grained microstructure that includes at least portions of the heated parts. For convenience, the zone of recrystallized material is identified in FIG. 7 by reference character “2Z”. It will be understood that, as illustrated in FIG. 7, the extent of the zone “2Z” has been exaggerated, for clarity of illustration. The result of the foregoing process is a unitary product 108 that includes the base elements 124, 126 and the cladding elements 128, 130, joined together (FIG. 7). Zone “2Z” includes a portion “2Q” of a unitary cladding element 167 that is joined with the base elements (FIG. 7).

The surfaces that are engaged are also at least partially subsumed in the zone “2Z” of recrystallized material (FIG. 7). Such surfaces may include the planar surfaces “2P₁”, “2P₂”, surfaces of the exposed parts 164, 166 of the interior surfaces 102, 104, and the internal wall surfaces 168, 170. It is believed that the relatively fine-grained microstructure results from such shearing, while the heated parts are at their hot working temperature.

As can be seen in FIG. 7, once the product 108 is formed, the product 108 includes the single, unbroken interior surface 106 and the single, unbroken exterior surface 114.

In another embodiment, illustrated in FIGS. 8-10, first and second cladded pipes 220, 222 include respective base elements 224, 226. At respective ends 236, 238 of the first and second cladded pipes 220, 222, the base elements 224, 226 have respective planar surfaces “3P₁”, “3P₂” that are orthogonal to an axis “3X” of the pipes 220, 222.

As can be seen in FIG. 8, first and second pockets 232, 234 are formed in the base elements 224, 226 for at least partially receiving extension portions 248, 250. The pockets 232, 234 are partially defined by inner internal walls 268, 270. In one embodiment, the internal walls 268, 270 each are positioned to define an acute angle relative to the axis “3X”.

The cladded pipes 220, 222 have respective interior surfaces 202, 204, and respective exterior surfaces 210, 212 (FIG. 8). As will be described, once the cladded pipes 220, 222 are joined together to form a unitary product 208, the interior surfaces 202, 204 preferably form a single, uniform interior pipe surface 206 (FIG. 10).

In the current embodiment, the base elements 224, 226 include external wall surfaces 274, 276 that are formed at the ends 236, 238 of the cladded pipes 220, 222. As can be seen in FIG. 8, in one embodiment, the external wall surfaces 274, 276 each define a predetermined angle relative to the respective exterior surfaces 210, 212 of the base elements 224, 226.

It is preferred that the first and second cladded pipes 220, 222 are initially positioned to locate the first end 236 opposite to the second end 238 to define a gap 240 therebetween. The cladded pipes 220, 222 are axially aligned, along axis “3X”. One or more heating elements 242 are positioned in the gap 240. As will be described, the heating element 242 is for heating sections, seen as first and second heated parts 244, 246, of the first and second cladded pipes 220, 222 to a hot working temperature, at which the heated parts 244, 246 are plastically deformable.

As can be seen in FIG. 8, in one embodiment, respective first and second extension

portions 248, 250 of the cladding elements 228, 230 extend toward each other and partially define the pockets 232, 234 to which the extension portions 248, 250 are adjacent. It will be understood that, for clarity of illustration, the extent to which the extension portions 248, 250 extend beyond the planar surfaces “3P₁”, “3P₂” is exaggerated in FIG. 8.

In one embodiment, the extension portion 248 is partially defined by an inner surface 252 and an opposed interior surface 202 (FIG. 8). The extension portion 250 is also partially defined by an inner surface 254 and the opposed interior surface 204.

The first pocket 232 is defined by the inner surface 252 and the internal wall surface 268. Similarly, the second pocket 234 is defined by the inner surface 254 and the internal wall surface 270.

Once the heating element 242 is in position, the heated parts 244, 246 are covered with an inert (non-oxidizing) atmosphere. Those skilled in the art would be aware of a suitable inert atmosphere. Also, those skilled in the art would be aware that the inert atmosphere may be held in place by a suitable container. It will be understood that the container and the inert atmosphere are omitted from the drawings for clarity of illustration.

Next, the at least one heating element 242 is energized, to heat the heated parts 244, 246. Once the heated parts 244, 246 are at their hot working temperature, the heating element 242 is removed from the gap 240. While the heated parts 244, 246 are at their hot working temperature, the first and second ends 236, 238 are engaged.

Only one heating element 242 is shown in FIG. 8, for clarity of illustration. Those skilled in the art would appreciate that the configuration and positioning of the heating element(s) 242 may be determined by practical considerations, e.g., any difficulties encountered in positioning the heating element(s) relative to the base elements and the cladding elements, and also any difficulties encountered in removing the heating element(s) from their respective positions once the first and second heated parts 244, 246 are at the hot working temperature.

It will be understood that, when the heated parts 244, 246 are at their hot working temperature, they are subject to plastic deformation. As described above, the hot working temperature is less than the melting temperature of the base elements 224, 226 and the cladding elements 228, 230. This means that, in contrast to conventional welding methods, the method of the disclosure does not involve first melting metal, and then allowing the metal to solidify.

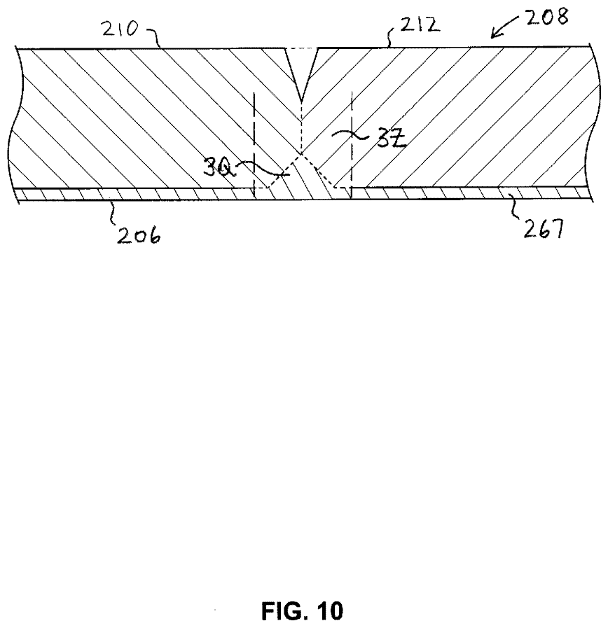

As can be seen in FIGS. 9 and 10, while the heated parts 244, 246 are at their hot working temperature, the first and second ends 236, 238 of the cladded pipes 220, 222 are engaged. In order to achieve this, one or both of the cladded pipes 220, 222 are subjected to a translocation motion, i.e., moved in the directions indicated in FIG. 9 by arrows “3A₁”, “3A₂”.

Once the first and second ends 234, 236 of the first and second cladded pipes 220, 222 are engaged, one or both of the pipes 220, 222 are subjected to an engagement motion, in which one or both of the pipes 220, 222 moves relative to the other. Those skilled in the art would appreciate that, alternatively, the engagement motion may commence before engagement as well.

From the foregoing, it can be seen that, when the first and second ends 236, 238 are engaged, the first portions thereof to engage are the first and second extension portions 248, 250. It will be understood that the extension portions 248, 250 are at least partially included in the heated parts 244, 246. FIG. 9 shows how the extension portions 248, 250 are deformed when the extension portions 248, 250 are urged against each other, due to the translocation motion.

It will be understood that, in an alternative embodiment, the extension portions 248, 250 may include respective bent segments thereof, formed for engagement with each other when the cladded pipes 220, 222 are engaged with each other end-to-end.

It will be understood that, in FIG. 9, the ends 236, 238 of the cladded pipes 220, 222 are shown spaced apart from each other for clarity of illustration, although the deformation illustrated in FIG. 9 occurs when the extension portions 248, 250 are engaged.

As can be seen in FIG. 9, when the extension portions 248, 250 engage each other, the extension portions 248, 250 are urged into their respective pockets 232, 234, as indicated by arrows “3B₁”, “3B₂”. The extension portions 248, 250 are deformed so that the inner surfaces 252, 254 are engaged with the internal wall surfaces 268, 270 respectively. For clarity of illustration, exposed parts of the interior surfaces 202, 204, are identified in FIG. 9 by reference characters 264, 266 respectively.

It will be understood that, shortly after the extension portions 248, 250 are deformed and urged into the pockets 232, 234, the planar surfaces “3P₁”, “3P₂” are urged against each other, and also the exposed parts 264, 266 are urged against each other.

When the heated parts are at their hot working temperature, the planar surfaces “3P₁”, “3P₂” engaged, and the exposed parts 264, 266 are engaged, then due to the engagement motion, the heated parts 244, 246 are at least partially subjected to shear, to form a zone of recrystallized material with a relatively uniformly fine-grained microstructure that includes at least portions of the heated parts. For convenience, the zone of recrystallized material is identified in FIG. 10 by reference character “3Z”. It will be understood that, as illustrated in FIG. 10, the extent of the zone “3Z” has been exaggerated, for clarity of illustration. The result of the foregoing process is the product 208 that includes the base element 224, 226 and the cladding elements 228, 230, joined together. It will be understood that “3Z” includes a portion “3Q” of a unitary cladding element 267 that is joined with the base elements (FIG. 10).

The surfaces that are engaged are also at least partially subsumed in the zone “3Z” of recrystallized material (FIG. 10). Such surfaces may include the planar surfaces “3P₁”, “3P₂”, the exposed parts 264, 266 of the interior surfaces 202, 204, and the internal wall surfaces 268, 270. It is believed that the relatively fine-grained microstructure results from such shearing, while the heated parts are at their hot working temperature.

Within the gap opposite the portion 3Q, filler material may be used to fill the gap in order to provide further protection or structure to the unitary product 208. The filler material may also provide protection to the connection in the zone of recrystallized material. Furthermore, although the area of the gap proximate the zone of recrystallized material is shown as being a sharp angle, it is understood that this may also be a smooth surface.

It will be appreciated by those skilled in the art that the disclosure can take many forms, and that such forms are within the scope of the invention as claimed. The scope of the claims should not be limited by the preferred embodiments set forth in the examples, but should be given the broadest interpretation consistent with the description as a whole.

I claim:

1. A method comprising:
(a) providing first and second cladded pipes having respective first and second base elements and first and second cladding elements secured to the first and second base elements respectively, the first and second base elements including respective first and second pockets at respective first and second ends of the first and second cladded pipes;
(b) positioning the first and second cladded pipes to locate the first end of the first pipe opposite the second end of the second pipe, wherein the first and second ends are spaced apart to define a gap therebetween;
(c) positioning at least one heating element in the gap, for heating heated parts of the first and second pipes to a hot working temperature at which the heated parts are plastically deformable;
(d) covering the heated parts with an inert atmosphere;
(e) energizing said at least one heating element, to heat the heated parts to the hot working temperature;
(f) removing said at least one heating element from the gap;
(g) while the heated parts are at the hot working temperature, engaging the first and second ends together;
(h) while the heated parts are at the hot working temperature, and while the first and second ends are engaged, moving one or both of the first and second cladded pipes relative to the other, wherein at least portions of the heated parts of the first and second cladding elements are extruded into the first and second pockets.

2. A method of joining cladded pipes comprising:
providing a first cladded pipe, the first cladded pipe including a first cladded pipe base element and a first cladded pipe cladding element secured to the first cladded pipe base element, the first cladded pipe base element including a pocket adjacent a first cladded pipe extension end of the first cladded pipe cladding element, the first cladded pipe extension end located at a connection end of the first cladded pipe;
providing a second cladded pipe, the second cladded pipe including a second cladded pipe base element and a second cladded pipe cladding element secured to the second cladded pipe base element, the second cladded pipe base element including a pocket adjacent a second gladded pipe extension end of the second cladded pipe cladding element, the second cladded pipe extension end located at a connection end of the second cladded pipe;
positioning the first and second cladded pipes such that the connection ends of the first and second cladded pipes face each other and define a gap therebetween;
heating sections of the connection ends of the first and second cladded pipes to a hot working temperature, the sections seen as heated parts of the first and second cladded pipes;
engaging the connection ends of the first and second cladded pipes; and
moving one or both of the first and second cladded pipes relative to the other, wherein at least portions of the first cladded pipe extension end and the second cladded pipe extension end are extruded into the pockets of the first cladded pipe and the second cladded pipe respectively.

3. The method of claim 2 wherein heating sections of the connection ends of the first and second cladded pipes is performed in an inert atmosphere.

4. The method of claim 3 wherein heating sections of the connection ends of the first and second cladded pipes comprises:
placing at least one heating element in the gap between the connection ends of the first and second cladded pipes; and
energizing the at least one heating element to heat the heated parts of the first and second cladded pipes to their hot working temperature.

5. The method of claim 2 wherein engaging the connection ends of the first and second cladded pipes comprises:
applying a translocation motion to at least one of the first cladded pipe or second cladded pipe to engage the connection ends.

6. The method of claim 5 wherein moving one or both of the first and second cladded pipes relative to the other comprises:
applying an engagement motion to at least one of the first or second cladded pipes.
